(19) United States
(12) Patent Application Publication
(10) Pub. No.: US 2025/0206212 A1
(43) Pub. Date: Jun. 26, 2025

(54) VEHICLE SEAT

(71) Applicant: TOYOTA BOSHOKU KABUSHIKI KAISHA, Aichi (JP)

(72) Inventors: Yoshiomi NISHIGAKI, Ichinomiya-shi (JP); Jun FUKAMI, Aichi-gun (JP)

(73) Assignee: TOYOTA BOSHOKU KABUSHIKI KAISHA, Aichi (JP)

(21) Appl. No.: 18/982,147

(22) Filed: Dec. 16, 2024

(30) Foreign Application Priority Data
Dec. 22, 2023 (JP) 2023-216782

(51) Int. Cl. B60N 2/70

(52) U.S. Cl. CPC B60N 2/7094

(57) ABSTRACT

Provided is a vehicle seat to inhibit an occupant from sliding forward when a vehicle slows down. A seat cushion provided in the vehicle seat according to the present disclosure is formed to have a higher stiffness toward a front side of the vehicle in a buttocks-supporting seat surface supporting the buttocks of an occupant in the vehicle seat.

### CROSS-REFERENCE TO RELATED APPLICATIONS

This application claims the benefit of Japanese Patent Application No. 2023-216782 filed on Dec. 22, 2023 with the Japan Patent Office, the entire disclosure of which is incorporated herein by reference.

### BACKGROUND

The present disclosure relates to a vehicle seat to be mounted in a vehicle.

Japanese Unexamined Patent Application Publication No. 2015-67170 describes a vehicle seat with a support member that is fixed within a seat frame and extends in seat front-rear directions like a bridge, thereby supporting a seat pad.

### SUMMARY

In a vehicle, there has been a problem that when a heavier occupant is seated on a vehicle seat, the occupant tends to slide forward when the vehicle slows down.

In one aspect of the present disclosure, it is desirable to inhibit the occupant from sliding forward when the vehicle slows down.

One aspect of the present disclosure is a vehicle seat to be mounted in a vehicle comprising a seat cushion. The seat cushion is formed such that a portion thereof corresponding to a buttocks-supporting seat surface has a higher stiffness toward a front side of the vehicle, the buttocks-supporting seat surface supporting buttocks of an occupant seated on the vehicle seat.

In the vehicle seat according to the present disclosure with the above-described configuration, in response to the greater weight of the occupant, it is possible to increase a front-rear supporting reaction force to be exerted on the occupant when the occupant is seated on the vehicle seat. This makes it possible to inhibit the occupant from sliding forward when the vehicle slows down.

In one aspect of the present disclosure, the seat cushion may comprise a cushion pad including the buttocks-supporting seat surface; and a support member supporting the cushion pad at a position below the buttocks-supporting seat surface. The support member may be a spring member formed to have a greater spring constant toward the front side of the vehicle.

In the vehicle seat according to the present disclosure with the above-described configuration, according to a position of the buttocks-supporting seat surface, the spring constant of each S-shaped spring is changed. This makes it possible to change the stiffness of a portion of the seat cushion according to the position on the buttocks-supporting seat surface.

### BRIEF DESCRIPTION OF THE DRAWINGS

Example embodiments of the present disclosure will be described hereinafter by way of example with reference to the accompanying drawings, in which:

FIG. 1 is a perspective view showing a configuration of a vehicle seat;

FIG. 2 is a sectional view showing a cushion pad supported by S-shaped springs;

FIG. 3 is a plane view showing a configuration of the S-shaped springs; and

FIG. 4 is an explanatory diagram illustrating front-rear supporting reaction forces.

### DETAILED DESCRIPTION OF EXEMPLARY EMBODIMENTS

### 1. First Embodiment

### [1-1. Configuration of Vehicle Seat]

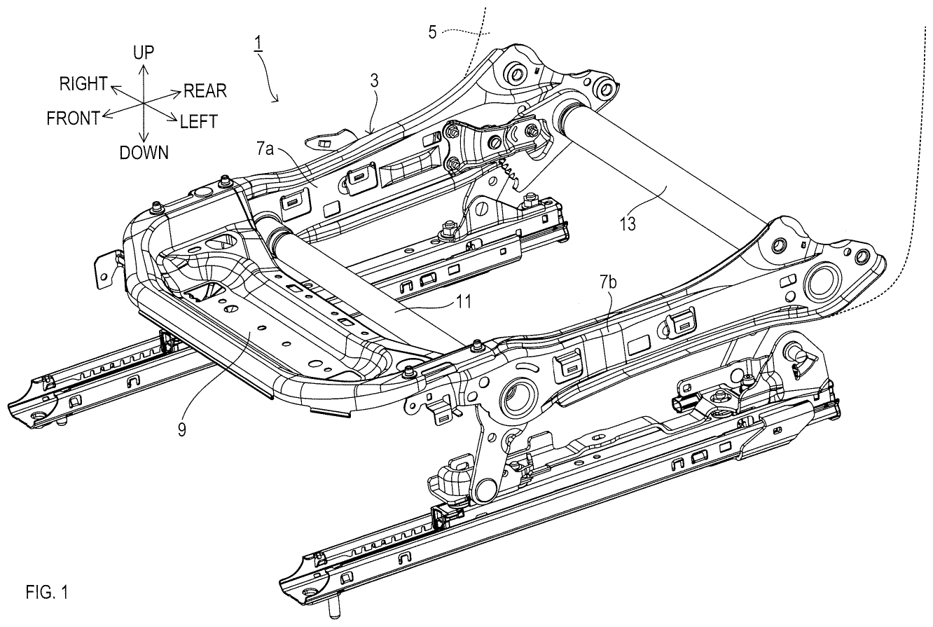

A vehicle seat 1 according to the present embodiment is mounted in a vehicle, and, as shown in FIG. 1, includes a seat cushion 3 and a seatback 5. The seat cushion 3 is a portion that supports the buttocks of an occupant. The seatback 5 is a portion that supports the back of the occupant.

The vehicle seat 1 according to the present embodiment is used as a seat for a passenger car. Directions shown in a description below and in the figures are directions in a state where the vehicle seat 1 is assembled with the vehicle. In the present embodiment, seat width directions correspond to vehicle left-right directions, and a seat front direction corresponds to a vehicle front direction.

The seat cushion 3 includes two side frames 7a, 7b, a front panel 9, a front pipe 11, and a rear pipe 13.

The front panel 9 connects front end portions of the two side frames 7a, 7b to each other. The front panel 9 supports the thighs of the occupant from below.

Each of the front pipe 11 and the rear pipe 13 is a round pipe made of metal. Each of the front pipe 11 and the rear pipe 13 connects the two side frames 7a, 7b to each other. The front pipe 11 is arranged rearward relative to the front panel 9. The rear pipe 13 is arranged further rearward relative to the front pipe 11, and connects a portion around a rear end of the side frame 7a and a portion around a rear end of the side frame 7b to each other.

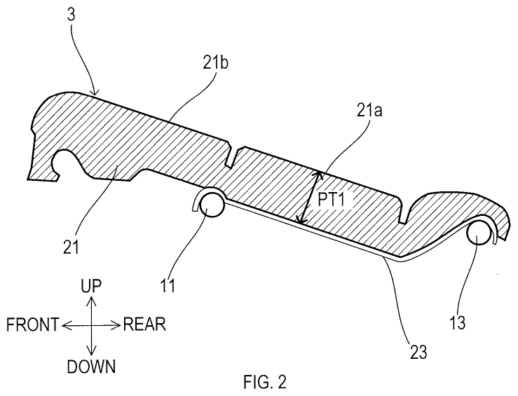

As shown in FIG. 2, the seat cushion 3 further comprises a cushion pad 21 and S-shaped springs 23. The cushion pad 21 is made of an elastic resin such as urethane.

The cushion pad 21 includes a buttocks-supporting seat surface 21a and a thighs-supporting seat surface 21b. The buttocks-supporting seat surface 21a supports mainly the buttocks of the occupant from below. The thighs-supporting seat surface 21b supports mainly the thighs of the occupant from below.

A thickness PT1 of a portion of the cushion pad 21 corresponding to the buttocks-supporting seat surface 21a is uniform regardless of a position on the buttocks-supporting seat surface 21a.

The S-shaped springs 23 span between the front pipe 11 and the rear pipe 13 under the cushion pad 21 and support a portion of the cushion pad 21 that corresponds to the buttocks-supporting seat surface 21a.

### [1-2. Configuration of S-shaped Spring]

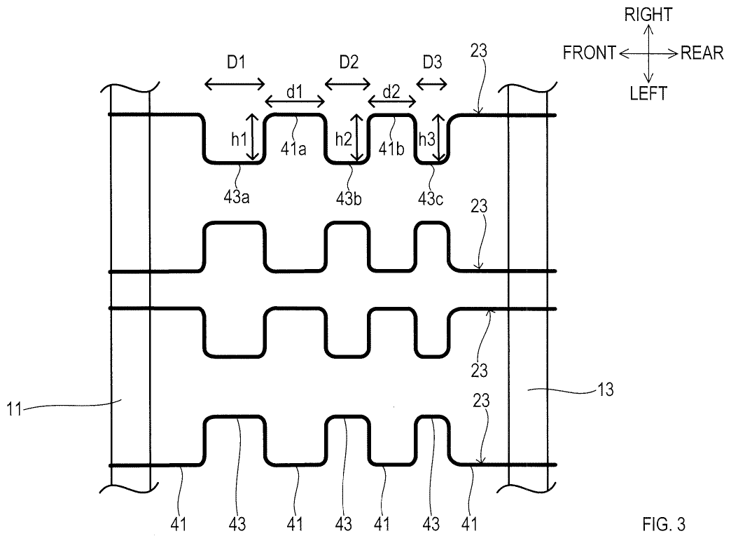

As shown in FIG. 3, each S-shaped spring 23 is formed into a square wave with bent portions. The S-shaped spring 23 may be formed into a sinusoidal wave with curved portions.

In the S-shaped spring 23, a straight portion 41 and a protruding portion 43 are arranged alternately. With such a configuration, the S-shaped spring 23 is formed with a plurality of the straight portions 41 and a plurality of the protruding portions 43 connected (continuous) along vehicle front-rear directions.

The straight portions 41 vary in length. The protruding portions 43 vary in distance (in other words, they vary in length).

The S-shaped springs 23 are each formed such that a distance D1 of a protruding portion 43a that is arranged in a forwardmost side of the vehicle is greater than a distance D2 of a protruding portion 43b that is arranged adjacent to the protruding portion 43a in a rear side of the vehicle. Additionally, the S-shaped springs 23 are each formed such that the distance D2 of the protruding portion 43b is greater than a distance D3 of a protruding portion 43c that is arranged adjacent to the protruding portion 43b in the rear side of the vehicle. A distance of each of the protruding portions 43 in the present embodiment can also be described as a length of each of the protruding portions 43 along the vehicle front-rear directions.

By forming the distance (length) of each of the protruding portions 43 as described above, the S-shaped springs 23 each have a larger spring constant on its portion located on the front side of the vehicle than on its portion located on the rear side of the vehicle. In other words, in the buttocks-supporting seat surface 21a of the cushion pad 21, the stiffness increases toward the front side of the vehicle.

A length d1 of a straight portion 41a between the protruding portion 43a and the protruding portion 43b is greater than a length d2 of a straight portion 41b between the protruding portion 43b and the protruding portion 43c. The protruding portion 43a and the straight portion 41a, which are adjacent to each other, may be the same in distance (length). That is, the distance D1 and the length d1 may be the same in length. Or, the distance D1 and the length d1 may be different in length. Similarly, for example, the distance D2 and the length d2 may be the same in length. Or, the distance D2 and the length d2 may be different in length.

A height (in other words, a projection amount) h1 of the protruding portion 43a, a height (a projection amount) h2 of the protruding portion 43b, and a height (a projection amount) h3 of the protruding portion 43c are identical to each other. The heights h1, h2, and h3 may be different from each other. The height h1 and the distance D1 may be identical to each other. The height h1 and the distance DI may be different from each other. The height h2 and the distance D2 may be identical to each other. The height h2 and the distance D2 may be different from each other. The height h3 and the distance D3 may be identical to each other. The height h3 and the distance D3 may be different from each other.

### [1-3. Front-Rear Supporting Reaction Force]

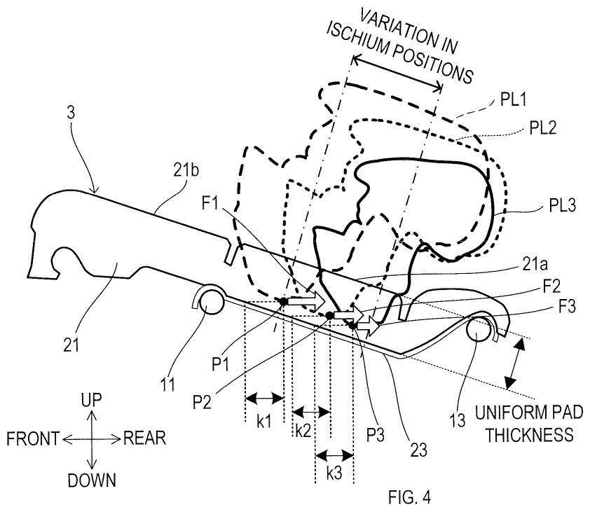

As shown in FIG. 4, depending on the size of the pelvis of the occupant (in other words, the size of the physique of the occupant), a position where the ischium of the occupant contacts the buttocks-supporting seat surface 21a of the cushion pad 21 varies.

Among three pelvises PL1, PL2, and PL3 shown in FIG. 4, when the occupant with a pelvis PL1, which is the largest pelvis, is seated on the vehicle seat 1, the ischium of the pelvis PL1 is positioned at a point P1. When the occupant with a pelvis PL2, which is the second largest pelvis, is seated on the vehicle seat 1, the ischium of the pelvis PL2 is positioned at a point P2. When the occupant with a pelvis PL3, which is the third largest pelvis, is seated on the vehicle seat 1, the ischium of the pelvis PL3 is positioned at a point P3.

As described above, when the occupant with a larger pelvis is seated, a position of the ischium of the occupant moves toward the front side of the vehicle.

The thickness PT1 of the portion of the cushion pad 21 corresponding to the buttocks-supporting seat surface 21a is uniform regardless of a position on the buttocks-supporting seat surface 21a. Thus, as shown in FIG. 4, an elongation k1, an elongation k2, and an elongation k3 of the S-shaped springs 23 are identical in magnitude.

The elongation k1 shows an elongation of the S-shaped springs 23 when the occupant with the pelvis PL1 is seated on the vehicle seat 1. The elongation k2 shows an elongation of the S-shaped springs 23 when the occupant with the pelvis PL2 is seated on the vehicle seat 1. The elongation k3 shows an elongation of the S-shaped springs 23 when the occupant with the pelvis PL3 is seated on the vehicle seat 1.

In addition, as described above, the S-shaped springs 23 each has a larger spring constant toward the front of the vehicle.

For this reason, a force F1 is larger than a force F2. Similarly, the force F2 is larger than a force F3.

The force F1 shows a front-rear supporting reaction force exerted on the ischium of the occupant when the occupant with the pelvis PL1 is seated on the vehicle seat 1. The force F2 shows a front-rear supporting reaction force exerted on the ischium of the occupant when the occupant with the pelvis PL2 is seated on the vehicle seat 1. The force F3 shows a front-rear supporting reaction force exerted on the ischium of the occupant when the occupant with the pelvis PL3 is seated on the vehicle seat 1. The front-rear supporting reaction force is a force exerted toward the rear side of the vehicle along the vehicle front-rear directions.

In general, since heavier people have larger pelvises, when the heavier occupant is seated on the vehicle seat, the buttocks of the occupant contact the seat cushion 3 on a front side of the buttocks-supporting seat surface 21a. With this configuration, the heavier the occupant, the greater front-rear supporting reaction force to be exerted on the occupant when the occupant is seated on the vehicle seat 1.

### [1-4. Effects]

With the above-described embodiment, the following effects can be obtained.

(1a) In the vehicle seat 1, in response to the greater weight of the occupant, it is possible to increase the front-rear supporting reaction force to be exerted on the occupant when the occupant is seated on the vehicle seat 1. This makes it possible to inhibit the occupant from sliding forward when the vehicle slows down.

(1b) In each S-shaped spring 23, the spring constant is not uniform and differs at different locations. Therefore, the stiffness of the seat cushion 3 differs according to the difference in the spring constant of the S-shaped spring 23.

### [1-5. Correspondence Relationship of Terms]

In the embodiment described above, the S-shaped springs 23 are one example of the support member and the spring member.

### 2. Other Embodiments

Although the embodiment of the present disclosure has been described so far, the present disclosure is not limited to the above-described embodiment and may take various forms.

(2a) The above-described embodiment shows a configuration in which the S-shaped springs 23 support the cushion pad 21. However, the support member that supports the cushion pad 21 is not limited to the S-shaped springs. The support member may be a pan frame, for example.

(2b) The above-described embodiment shows a configuration in which the stiffness of the seat cushion 3 is changed by changing the distances of the protruding portions 43 of the S-shaped springs 23. However, the stiffness may be changed by any method other than changing the distances of the protruding portions 43 of the S-shaped springs 23.

(2c) Two or more functions of a single element in the above-described embodiments may be achieved by two or more elements or a single function of a single element may be achieved by two or more elements. The functions of two or more elements may be achieved by a single element or a single function of two or more elements may be achieved by a single element. Part of the configuration in the above-described embodiments may be omitted. Furthermore, at least part of the configuration of the above-described embodiments may be added to or replaced by a configuration of other embodiments.

What is claimed is:

1. A vehicle seat to be mounted in a vehicle, the vehicle seat comprising:
a seat cushion formed such that a portion thereof corresponding to a buttocks-supporting seat surface has a higher stiffness toward a front side of the vehicle, the buttocks-supporting seat surface supporting buttocks of an occupant seated on the vehicle seat.

2. The vehicle seat according to claim 1,
wherein the seat cushion comprises:
a cushion pad including the buttocks-supporting seat surface; and
a support member supporting the cushion pad at a position below the buttocks-supporting seat surface, and
wherein the support member is a spring member formed to have a greater spring constant toward the front side of the vehicle.

3. The vehicle seat according to claim 2,
wherein the spring member as the support member includes a plurality of the straight portions and a plurality of the protruding portions and is formed such that a straight portion and a protruding portion are arranged alternately.
